(19) United States
(12) Patent Application Publication
(10) Pub. No.: US 2016/0159180 A1
(43) Pub. Date: Jun. 9, 2016

(54) Automobile Having a Suspension with a Highly Progressive Linkage and Method for Configuring Thereof

(71) Applicant: Dennis Palatov, Portland, OR (US)

(72) Inventor: Dennis Palatov, Portland, OR (US)

(21) Appl. No.: 14/563,960

(22) Filed: Dec. 8, 2014

(51) Int. Cl. B60G 3/26; B60G 13/18; B60G 11/56

(52) U.S. Cl. CPC B60G 3/26; B60G 11/56; B60G 13/18

(57) ABSTRACT

An Automobile having a Suspension with a highly Progressive linkage is disclosed. Method for configuring such a linkage to achieve desired performance is provided.

The present invention relates to Automobiles having a Suspension, said Suspension further having a Linkage for controlling the effective spring and damping rate of the Suspension in response to Wheel travel.

### DEFINITION OF TERMS

Within the context of the present invention, its specification and the corresponding claims, the following terms have the specific meaning set forth below. This meaning may differ from similar terms used in other contexts, and other terms may commonly be used to describe similar concepts and mechanisms elsewhere. Only the following terms and meanings shall apply within the context of the present invention, its specification and the corresponding claims.

Automobile within the context of the present invention is a vehicle having at least three Wheels, intended to operate primarily on paved road surfaces. A typical Automobile of the present invention will have Total Wheel Travel of less than six inches. An Automobile of the present invention comprises at least a Sprung Mass, at least three Wheels and a Suspension mechanically coupling each of the Wheels individually to the Sprung Mass, said Suspension comprising at least one Axle.

Suspension is the combination of mechanical components whose combined effect is to mechanically couple an Automobile's Wheels to its Sprung Mass in order to allow the Wheels to move relative to the Sprung Mass and to simultaneously exert control over such motion. A typical Suspension comprises at least one of each of Control Arms, Dampers and Springs mechanically coupled to each Wheel of an Automobile. The present invention pertains particularly to Automobiles utilizing Suspensions which further comprise a Linkage to mechanically couple Wheels to Dampers and Springs in a manner that can be controlled by varying certain design parameters.

Sprung Mass comprises all components of an Automobile with the exception of Wheels, Suspension, and components comprised therein. In typical embodiments Sprung Mass will comprise chassis, drivetrain, bodywork and passenger and cargo accommodations. In at least some of the analyses of the present invention, Sprung Mass is considered as a stationary reference frame with respect to which the motion of Wheels is controlled by the Suspension. Other analyses of the present invention consider the motion of the Sprung Mass relative to road surface, as a sum result of the motion of all Wheels relative to the Sprung Mass, while all Wheels substantially maintain contact with the road surface. In such analyses the road surface is considered as a fixed reference frame comprising substantially a flat horizontal plane.

Unsprung Mass comprises the Wheels, Suspension and all components comprised therein which are movable relative to the Sprung Mass responsive to Wheel travel.

When used herein, Wheel travel refers to vertical motion of the Wheels relative to the Sprung Mass, treating the Sprung Mass as a stationary frame of reference. In such analyses it is assumed that contact between Wheel and road surface, including any variations therein, is substantially maintained and results in a certain Wheel Force, but the road surface itself is not considered. Bump Travel is the available vertical travel of a Wheel between Ride Height and Full Bump. Droop Travel is the available vertical travel of a Wheel between Ride Height and Full Droop. Total Wheel Travel is the available vertical travel of a Wheel between Full Droop and Full Bump and is the sum of Droop Travel and Bump Travel.

Damper (also commonly referred to as shock absorber or shock) is a component of the Suspension who's purpose is to absorb kinetic energy by converting it into another form. A typical damper in the art consists of a hydraulic cylinder with a piston that comprises one or more restricted openings to allow passage of a limited amount of hydraulic fluid. Kinetic energy is typically absorbed by converting mechanical motion to heat in the hydraulic fluid by generating a resistance to motion, typically responsive to speed of such motion, and subsequently releasing the resulting heat to the surrounding environment. Other types of dampers known in the art include friction, pneumatic, elastomeric and electromechanical types. A portion of a Damper is typically fixed with respect to Sprung Mass and another portion is movable responsive to vertical Wheel travel relative to Sprung Mass. When used herein, Damper travel or Damper motion refers to the motion seen at the portion of the Damper that is movable with respect to the Sprung Mass.

Spring is a component of the Suspension who's purpose is to store and then return kinetic energy. Most common examples of springs employ elastic flexing of a material such as metal or fiber reinforced plastic to perform their function. They include but are not limited to coil springs, leaf springs and torsion bars. Other types of springs such as pneumatic and elastomeric are also known. One portion of a Spring is typically fixed with respect to Sprung Mass and another portion is movable responsive to vertical Wheel travel relative to Sprung Mass. When used herein, Spring travel or Spring motion refers to the motion seen at the portion of the Spring that is movable with respect to the Sprung Mass.

Control Arm within the context of the present invention is a mechanical component of the Suspension that mechanically couples a Wheel to the Sprung Mass and restricts the motion of a Wheel relative to Sprung Mass in at least one degree of freedom. A typical Suspension known in the art employs a plurality of Control Arms at each corner of an Automobile to control the motion of the corresponding Wheel in all degrees of freedom except vertical. Vertical motion is then typically controlled by the combination of a Damper and a Spring, in some cases further employing a Linkage.

Linkage is the combination of mechanical or hydro-mechanical components who's effect is to mechanically couple a Wheel to a corresponding Spring or Damper while achieving a predetermined Motion Ratio at predetermined points in Wheel travel. A typical Linkage in embodiments of the present invention comprises a bellcrank component to control mechanical leverage between Wheel and Spring or Damper and to also change direction of motion as it is transmitted from Wheel to Spring or Damper in order to suit packaging requirements. Many examples of Linkages are known the art. The present invention teaches a method of configuring a Linkage to achieve a specific predetermined Progression and a corresponding predetermined Wheel Rate Gain which enables an Automobile constructed in accordance with the present invention to achieve suspension performance objectives.

Axle within the context of the present invention is the sum combination of left and right Wheels and the corresponding Suspension components at one end of an Automobile, an end being defined as either front or rear. An Axle of the present invention comprises a left Wheel and a Right wheel, said Wheels being substantially symmetrically disposed about the longitudinal axis of an Automobile, and a Suspension further comprising at least a left and a right Control Arm, a left and a right Spring and a left and a right Damper. Arrangements such as rear suspensions commonly found on some ATVs wherein both rear wheels are mechanically coupled to the Sprung Mass by means of a Suspension comprising a single common Control Arm, a single Damper and a single Spring, do not constitute an Axle within the context of the present invention. Other commonly used definitions of Axle, such as those referring to specific mechanical components, do not apply within the context of the present invention.

Stabilizer (also commonly referred to as anti-roll bar or anti-sway bar) is a mechanical component used in some Suspension designs to elastically couple the motion of left and right Wheels within an Axle in order to increase Roll Stiffness at that Axle. Stabilizers are usually implemented by means of torsion bars mechanically coupled to Control Arms on each side of the Axle, and further mechanically coupled to Sprung Mass of the Automobile. The function of a Stabilizer is responsive to the motion of the Sprung Mass in roll relative to road surface, and unresponsive to motion of the Sprung Mass in pitch and heave relative to road surface.

Third Spring is a suspension component sometimes employed in racing Automobiles with high aerodynamic downforce, to increase Wheel Rate at an Axle responsive to downward motion of the Sprung Mass in heave or pitch. The primary purpose of a Third Spring is to maintain ground clearance of the Automobile and keep the Suspension from Bottoming Out when it is subjected to high levels of aerodynamic downforce (high speed), while enabling lower Wheel Rate when such downforce is not present (low speed) in order to improve mechanical grip. A Third Spring is typically hydraulically coupled to both Dampers at an Axle and is active only within a predetermined range of Wheel travel relative to Sprung Mass. The function of a Third Spring is responsive to net motion of Sprung Mass relative to road surface in heave and pitch, usually within a predetermined range only, and unresponsive to motion of Sprung Mass in roll.

Bump Stop is a mechanical component of a Suspension that limits Wheel travel at Full Bump. Many Bump Stop designs known in the art are configured as an elastomeric component in parallel with the corresponding Spring who's effect is to greatly increase Wheel Rate as the Wheel approaches the top of its mechanical travel range and to therefore cushion any occurrence of Bottoming Out. A typical Bump Stop is configured to be active only in a proportionally small, uppermost range of total available Wheel travel. The function of a Bump Stop is responsive to Sprung Mass motion in pitch, roll and heave, provided such motion falls within the range of Wheel travel within which a Bump Stop is active.

Helper Spring is another variation that provides a means of increasing Wheel Rate in a predetermined upper portion of available Wheel travel by placing a second Spring in parallel with the main Spring unit.

Spring Rate is the amount of change in force exerted by a Spring responsive to a unit of Spring travel, measured at the spring and expressed in force per unit travel. Most commonly Springs are constructed to have a single predetermined Spring Rate. Multi-Rate Springs can be constructed by varying winding pitch for coil Springs or controlling other construction parameters. Practical manufacturing considerations often restrict this practice to two predetermined Spring Rates, with the stiffer Spring Rate coming into effect at a point where all the coils of the softer portion of the spring are fully collapsed due to compression. Multi-Rate and continuously variable Springs are technically possible but are seldom used in practice due to expense and difficulty of controlling their manufacture. Construction of Springs to achieve a desired Spring Rate is well known in the art and is outside the scope of the present invention.

Damping is the force exerted by a Damper responsive to speed of Damper travel, measured at the Damper and expressed in force at a given speed. Damping is usually non-linear and Dampers are typically configured to provide predetermined Damping characteristics at various predetermined speeds. Means and methods for such configuration are well known in the art and are outside the scope of the present invention.

Corner Weight as used herein is the portion of the overall downward force experienced by Sprung Mass due to gravity that is supported by the Suspension at a particular corner in a 1.0 g vertical loading condition, with the Automobile at rest, using the road surface as a fixed reference plane. Unsprung Mass is not considered as part of Corner Weight within the context of the present invention.

Wheel within the context of the present invention and its specification is the complete rim, tire and hub assembly including all components necessary to mechanically couple the Wheel to one or more Control Arms.

Wheel Force (also referred to in the art as tire force) within the context of the present invention is the vertical force exerted upon a Wheel by the road surface in a particular loading condition, with Sprung Mass as a fixed reference frame. For the purposes of analyses herein, the effects of Unsprung Mass on Wheel Force are not considered.

Ride Height in the context of the present invention is the vertical position of a Wheel relative to Sprung Mass that results when the Automobile is at rest, subjected only to 1.0 g vertical loading with no lateral or longitudinal loads, and all forces acting on the Suspension are in equilibrium. In the context of the present invention, Ride Height occurs when Wheel Force is equal to Corner Weight.

Full Bump is the upper mechanical limit of vertical Wheel travel relative to the Sprung Mass. The geometric position of Full Bump is usually determined by the mechanical construction of Control Arms, Springs, Bump Stops, Dampers and any associated Linkage. The Wheel Force necessary to achieve Full Bump is determined by the Spring Rate and Motion Ratio at that particular point in Wheel travel, as detailed elsewhere in this specification. It is generally desirable to have Full Bump correspond to Wheel Force of at least 4.0 times Corner Weight to prevent Bottoming Out in most normal operating conditions.

Full Droop is the lower mechanical limit of vertical Wheel travel relative to the Sprung Mass. Full Droop occurs when Wheel Force is zero. A Wheel in Full Droop cannot contribute to dynamic control of the Automobile due to having zero traction as a result of zero Wheel Force.

Bottoming Out occurs when Wheel Force exceeds that corresponding to Full Bump. In this condition the Wheel becomes mechanically fixed with respect to the Sprung Mass, any further increase in Wheel Force does not produce any further motion of the Wheel relative to Sprung Mass and any components of the Suspension have no further effect. Wheel Rate in the Bottoming Out condition is infinity. This condition is hazardous with respect to Automobile dynamic behavior and its structural integrity, and should be avoided.

Motion Ratio within the context of the present invention is the ratio of motion as measured at a Spring or Damper, relative to vertical motion of the corresponding Wheel. Motion Ratio is the result of the specific geometry of the mechanical coupling between Wheel and Spring or Damper, any Control Arms and any Linkage comprised therein. The present invention teaches means and methods of controlling Motion Ratio to produce desired Suspension response to Wheel motion at different points in vertical Wheel travel. As used herein, a Motion Ratio of less than 1.0 corresponds to Spring or Damper travel that is proportionally less than corresponding Wheel travel. Therefore a Motion Ratio of 0.5 means that for every unit of vertical travel of the corresponding Wheel, a Spring or Damper moves 0.5 times as far. Motion Ratios for Suspensions not employing a Linkage are substantially fixed by design and fall in the range of 0.4 to 0.9, with approximately 0.6 being the most common Suspensions employing a Linkage have the potential to vary Motion Ratio responsive to vertical Wheel travel but in Automobile applications are most commonly designed to achieve a fixed Motion Ratio of approximately 1.0.

Progression as used herein is the ratio of Motion Ratio at Full Bump and that at Full Droop. Progression is determined by the geometric configuration of a Linkage, as detailed elsewhere in this specification. When Motion Ratio at Full Bump is greater than Motion Ratio at Full Droop, the resulting Progression is greater than 1.0 and the Linkage can be described as Progressive. Linkage geometries resulting in Progression of 1.0 are considered Linear within the context of the present invention, and those having Progression of less than 1.0 are termed Regressive. Linkage geometries having Progression of 1.2 and above are termed Highly Progressive.

Wheel Rate in the context of the present invention is the amount of change in Wheel Force necessary to achieve a unit of Wheel travel. It is a combination of the Spring Rate and the mechanical leverage afforded the Spring over the Wheel due to Motion Ratio. Since Motion Ratio simultaneously affects both the instantaneous mechanical leverage and the relative magnitude of Spring and Wheel travel, the effective Wheel Rate at any given point in Wheel travel is Spring Rate multiplied by the square of Motion Ratio. Therefore, given a Motion Ratio of 0.5, the corresponding Wheel Rate is 0.25 times the Spring Rate. For a Motion Ratio of 2.0 the resulting Wheel Rate is 4.0 times the Spring Rate.

Wheel Rate Gain as used herein is the ratio of Wheel Rate at Full Bump to that at Full Droop. From the definitions above, Wheel Rate Gain is the square of Progression. This exponential relationship is an essential element of the present invention.

Sprung Natural Frequency, also commonly referred to in the art as simply Natural Frequency, is the first order resonant frequency of the mass-spring system comprised of Sprung Mass and virtual Springs equivalent to Wheel Rate at each corner of the Automobile. The concept is well known in the art and pertains to configuring Springs and Dampers to remove kinetic energy from the Sprung Mass in order to generate optimum passenger comfort, as well as to control large amplitude, low frequency motions of the Sprung Mass. Through testing and analysis it has become known in the art that Sprung Natural Frequencies in the 1 Hz-4 Hz are desirable and consequently most passenger Automobiles fall within that range. To the extent that Sprung Mass motion relative to road surface may affect the specifics of a particular suspension design, Sprung Natural Frequency may also have an effect on a Automobile's dynamic behavior. Detailed analysis of Sprung Natural Frequency is well known in the art and is outside the scope of the present invention.

Unsprung Natural Frequency within the context of the present invention is the first-order resonant frequency of the mass-spring system comprised of the Unsprung Mass and the Wheel Rate equivalent virtual Spring at a particular corner of the Automobile, with Sprung Mass used as a stationary reference. Increasingly the Unsprung Natural Frequency analysis is being used in tuning competition car Dampers to remove kinetic energy from the Unsprung Mass in the small amplitude, high frequency range that is characteristic of a Wheel reacting to small road surface imperfections. This form of analysis is directed at minimizing Wheel Force variation in order to optimize mechanical grip between Wheel and road surface and its requirements are usually conflicting with Sprung Natural Frequency analysis. Detailed Analysis of Unsprung Natural Frequency is known in the art and is outside the scope of the present invention.

### BACKGROUND OF THE INVENTION AND RELATED ART

The design of an Automobile and its Suspension is typically a set of compromises between numerous and conflicting requirements. On the one hand are the requirements for passenger comfort and high mechanical grip between Wheels and road surface, which call for low Wheel Rate and extended Wheel travel, particularly in Droop in order to keep Wheels in contact with the road surface. On the other hand are the requirements for controlling undesirable motion of the Sprung Mass in response to acceleration and cornering loads, as well as the need to accommodate a wide range of load conditions due to varying cargo load or strong aerodynamic forces in some racing Automobiles. The latter set of requirements call for high Wheel Rate and reduced Wheel travel. A number of approaches have been developed in the art in attempts to accommodate the conflicting requirements. Some of the more common are listed in the following paragraphs.

Variable rate Springs are one such attempted solution. An example of a variable rate spring is the pneumatic spring system commonly found on heavy cargo Automobiles. The system is adjusted by varying air pressure inside the pneumatic spring by means of an onboard air compressor. Such a system is effective at compensating for varying cargo loads. However it is complex, expensive, requires maintenance, is typically too slow to respond to load changes resulting from dynamic weight transfer and does not provide a means to adjust Damping to match the varying Spring Rate. Electronically controlled Dampers that have been increasingly implemented on luxury passenger cars do offer a means of Damping control in such setups but at the expense of considerable complexity, weight and cost.

Multi-rate Springs, such as coil Springs with varied winding pitch, or those made up of a plurality of different rate springs connected in series, are a simpler solution. They function on the premise that as the total Spring is compressed, the softer portion will collapse first and once that takes place, the effective rate of the Spring becomes that of the stiffer portion. Such solutions in practice are limited in value due to the fact that the transition from soft to hard rate is an abrupt one and can occur unpredictably due to varying dynamic weight transfer. This can lead to unpredictable Automobile handling due to a sudden change in roll stiffness at a loaded Axle. Multi-rate Springs do not offer a means to adjust Damping to match the varying Spring Rate and require expensive electronically controlled Dampers if such matching is to be attempted.

Helper Springs, Third Springs and Bump Stops have also been used to increase effective Spring Rate at or near Full Bump. Such devices have limited effectiveness as they are typically only active in a small portion of the total Wheel travel, offer a relatively abrupt increase in Spring Rate and have no inherent means of matching Damping to the varying Spring Rate.

A number of Control Arm geometric configurations have been developed in the art to transfer a portion of Wheel Force generated under accelerated conditions, either laterally or longitudinally, to the Sprung Mass directly through Control Arms, partially bypassing Springs and Dampers and therefore increasing effective Wheel Rate. Some examples of such geometries known in the art include Anti-Dive and Anti-Squat which are active in pitch. Raising the geometric roll centers relative to the center of gravity of the Sprung Mass is used to accomplish similar effect in roll. While such approaches have been shown to be effective in controlling motions of the Sprung Mass in response to longitudinal and lateral acceleration forces acting upon an Automobile, by their nature of partially bypassing Springs and Dampers they correspondingly reduce the effectiveness of the Suspension and can lead to instability and loss of traction over uneven road surfaces. Again, due to a lack of a known better solution, such geometries are commonly used compromises.

Stabilizers are another commonly used means of attempting to control Sprung Mass motion, particularly in roll, while maintaining a lower Wheel Rate in some situations. When Sprung Mass moves in roll, a Stabilizer flexes increasing the effective Wheel Rate on the loaded side of the Axle and correspondingly reducing the effective Wheel Rate on the unloaded side of the Axle, thereby reducing the amount of Sprung Mass motion in roll for a given lateral loading. Since Stabilizers elastically couple left and right Wheel movement in an Axle, they do have the undesirable effect of increasing the effective Wheel Rate in singe-wheel bump situations. Stabilizers are ineffective in heave and pitch and do not offer any means to account for longitudinal weight transfer and the corresponding change in loads that comes from longitudinal acceleration of the Sprung Mass.

In some applications, such as racing Automobiles having a high level of aerodynamic downforce, it is common practice to design suspensions with very high Wheel Rates to inhibit substantially all Sprung Mass motion. This practice results in very small amounts of Wheel travel. A traditional Suspension design with Spring and Damper directly coupled to a Control Arm results in a low Motion Ratio, typically in the 0.5 to 0.7 range. This in turns means that Damper travel is reduced to the point where its ability to absorb kinetic energy is greatly inhibited due to insufficient amount of motion. To counteract this, Linkage suspensions have been developed to bring the Motion Ratio to 1.0 or above. Doing so enhances the function of the Damper and has the added benefit of locating the Damper inboard, out of the airstream. The primary purpose of such Linkages, including the author's early designs, has been to increase Motion Ratio in order to improve Damper performance.

Progressive Linkages have been utilized and are well known on the rear Suspension of motorcycles and ATVs. Examples of such Linkages are taught by Domenicali, Sommers and Morgan. In motorcycle and some ATV applications the Linkage is most commonly applied to the single swingarm of the rear suspension. Such arrangements do not constitute an Axle within the context of the present invention due to not having a means of separately controlling the motion of right and left Wheels, even in designs when two rear wheels are present. Consequently in such designs no consideration is given to controlling the motion of the Sprung Mass in roll, as it is not a factor in such applications. The interaction between front and rear Suspension systems is also not typically considered. Analysis of such Linkages in the art focuses on Leverage Ratio (which is the inverse of the Motion Ratio of the present invention). No consideration appears to be given to its effect on Wheel Rate although its effect on Damper travel speed is typically considered. The primary considerations of Progression in such designs is preventing Bottoming Out in extreme maneuvers such as jumps or traversing rough terrain while maintaining a comfortable ride in less extreme conditions.

The author's analysis of a number of known Automobile Suspension Linkages in the art has shown Linear, slightly Progressive, or in the case of such designs as the Ariel Atom and Stohr F1000, Regressive geometries. Based on this analysis, one possible conclusion is that any non-linearity in the linkage is at least in some cases accidental and resulting from only considering one point in vertical Wheel travel during the design phase, rather than intentional. Many Automobile Suspensions utilizing Linkages also utilize Stabilizers, Third Springs and Bump Stops as solutions for implementing a variable Wheel Rate under some conditions and controlling Sprung Mass motion. In the case of the Ariel Atom specifically, dual-rate Springs are used while still retaining Regressive geometry. These and other examples show that while Suspension Linkages are well known, and Progressive linkages are known in motorcycle and ATV designs where they are applied to controlling comfort and Bottoming Out only, utilizing a highly Progressive Linkage in an Automobile Suspension as a means of controlling Sprung Mass motion in roll, pitch and heave, as taught in the present invention, is not known and is not obvious to those of ordinary skill in the art.

All the designs discussed above add complexity, weight and expense to an Automobile while providing only a partially effective solution. Nevertheless, due to a lack of a known better solution, all are commonly used in the art and often in combination.

What is needed is an Automobile with a Suspension design that provides extended droop travel and a high degree of compliance over small road irregularities while effectively controlling Sprung Mass motion and reducing the possibility of Bottoming Out. It is desirable that such a design inherently maintain Damping that is appropriately matched to Spring Rate and provide a smooth, predictable change in Spring Rate in response to varying load conditions over the full range of Wheel travel. The Automobile and Suspension of the present invention answers this need by applying a separate highly Progressive Linkage at each Wheel of at least one and preferably of two Axles, thereby achieving both the desired Suspension compliance and the desired control of Sprung Mass motion, resulting in enhanced load handling capacity and improved handling under all conditions without incurring excessive weight, complexity and cost.

### SUMMARY OF THE INVENTION

A first objective of the present invention is to provide a Automobile who's suspension has sufficient Wheel travel and low enough Wheel Rate for compliance with road surface irregularities, and simultaneously exhibits good control over Sprung Mass motion in response to both longitudinal and lateral acceleration of the Sprung Mass relative to road surface. A second objective is to provide an Automobile that exhibits safe and consistent handling characteristic over a wide range of load conditions, including varying cargo loading and aerodynamic downforce loading, while reducing possibility of Bottoming Out. A third objective is to eliminate partial solutions which are only active under certain conditions, in order to both reduce cost and complexity of the Automobile and to enhance the predictability and consistency of its handling characteristics by avoiding abrupt changes in Wheel Rate responsive to Wheel travel.

In order to meet the above stated objectives, the present invention teaches a Suspension Linkage with geometry configured to provide an optimized Wheel Rate at Ride Height, a low Wheel Rate at Full Droop, a substantially higher Wheel Rate at Full Bump and a smooth transition between the rates throughout the available range of Wheel travel. In accordance with the present invention, this is accomplished by configuring the geometry of the Linkage so as to provide a base Motion Ratio at Ride Height, a lower Motion Ratio at Full Droop and a higher Motion Ratio at Full Bump. The preferred embodiments of the present invention will utilize the commonly available coilover Spring and Damper units, with the Spring being concentrically co-located with the Damper, in order to efficiently maintain Damping substantially matched to Wheel Rate at all times. In such embodiments this is accomplished by ensuring that the Linkage acts simultaneously and equally on both Spring and Damper. Other embodiments such as those having separate Linkages for Spring and Damper will become apparent to those skilled in the art based on the teachings of the present invention, without departing from the scope of the present invention.

### BRIEF DESCRIPTION OF THE DRAWINGS

The present invention is described herein with reference to the following drawings:

FIG. 1 is an illustration of a first embodiment of the Automobile Suspension of the present invention showing an Axle with Suspension mechanically coupling Wheels 200 to Sprung Mass 100 by means of Control Arms 300, Dampers 400, Springs 500 and a left and a right Linkage each comprising a bellcrank 600 and a pushrod 610.

FIG. 2 is an illustration of a second embodiment of the Automobile Suspension of the present invention.

FIG. 3 shows the relationship between Suspension Linkage components of one embodiment and the geometry used for analysis thereof.

FIG. 4 is a diagram showing the geometry used in the analysis of one embodiment of Suspension Linkage of the present invention at three points corresponding to Rideheight, Full Droop and Full Bump.

FIG. 5 illustrates an embodiment of the Automobile of the present invention having three wheels and a Suspension comprising one Axle; and

FIG. 6 illustrates an embodiment of the Automobile of the present invention having four wheels and a Suspension comprising two Axles.

### DETAILED DESCRIPTION OF AN EMBODIMENT OF THE INVENTION

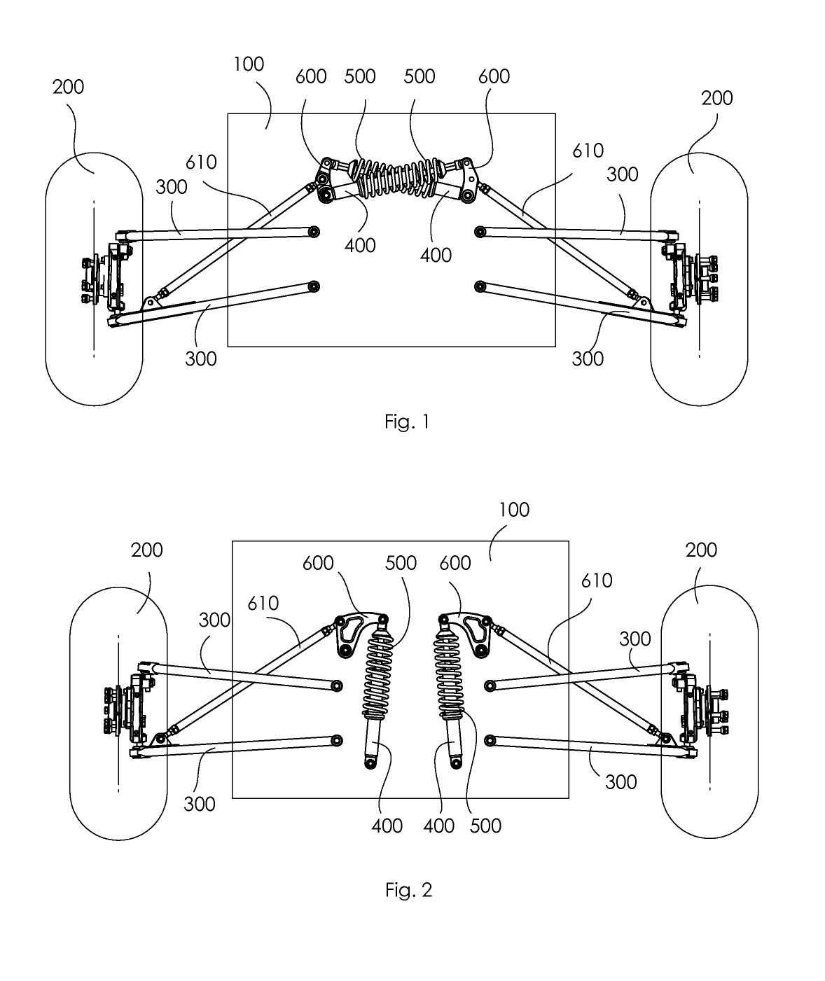

Two representative embodiments of the present invention are illustrated in FIG. 1 and FIG. 2, respectively. The illustrations show how different orientations of Dampers 400 and Springs 500 can be accommodated by adjusting the geometry of bellcrank 600 and length of pushrod 610. Both bellcranks and pushrods are well known in the art. Examples of Control Arms 300 are also shown. The examples shown herein are illustrative and not limiting. A great variety of linkages and component orientations are known in the art. The present invention pertains to configuring a Linkage to have a specific Progression and corresponding Wheel Rate Gain, and to using a distinct Linkage to mechanically couple each Wheel 200 within at least one Axle of an Automobile Suspension to the corresponding Spring 500 and/or Damper 400 which are further coupled to Sprung Mass 100.

The specific analysis of geometry necessary to achieve the Progression taught herein will vary depending on the details of each embodiment. Such analysis will become apparent to those skilled in the art based on the illustrative examples cited below.

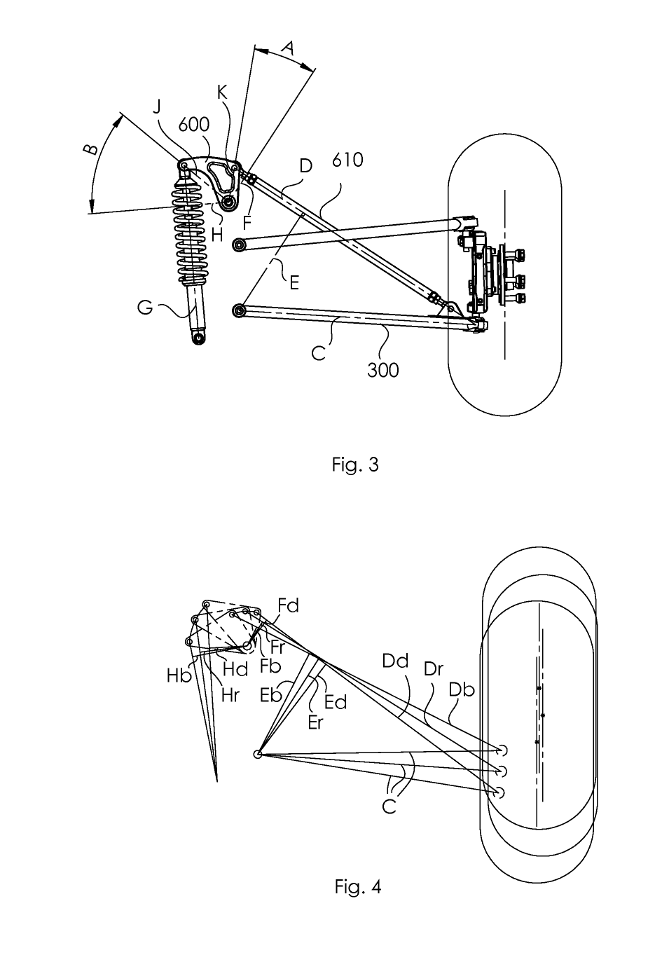

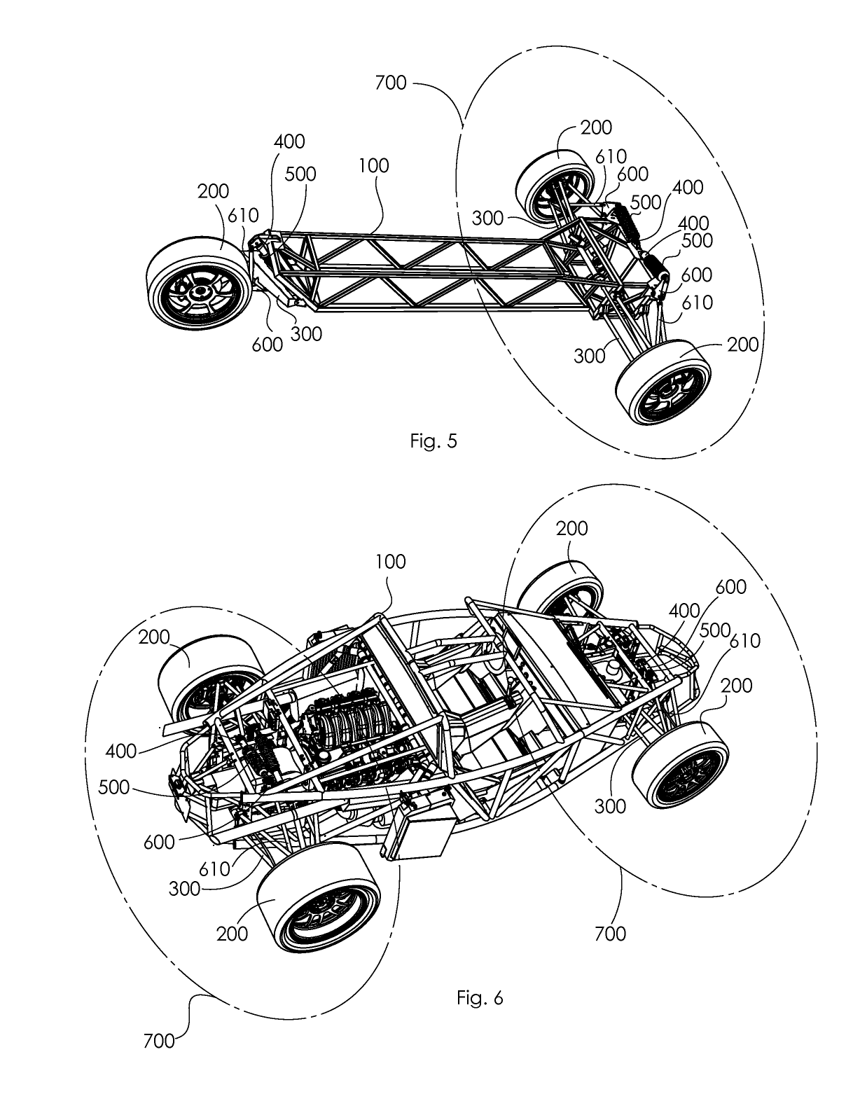

FIG. 3 shows the relationship between components of a Suspension of the present invention and the geometry utilized in the analysis thereof. For the purpose of describing the present invention, a Linkage being coupled to the corresponding Wheel by means of lower Control Arm 300 is shown. This is a common Linkage configuration in the art, although Linkages coupling to other control arms or directly to Wheel are also known. FIG. 3 illustrates the key geometric parameters used in the analysis of a Linkage of the present invention. The Linkage of the present invention is best described in terms of wheel-side and spring-side geometries and the relationship between them. It shall be apparent to those skilled in the art how such analysis can be applied to other Linkage configurations.

On the wheel-side portion of the Linkage the control arm lever C together with instantaneous pushrod D (which may or may not be substantially aligned with the mechanical pushrod 610) together result in the instantaneous wheel lever arm E at a given point in wheel travel. The geometry and orientation of bellcrank 600, in combination with a specific length of D, results in instantaneous wheel-side bellcrank lever arm F at same point in wheel travel. The wheel-side bellcrank angle A as illustrated has a positive value within the context of the present invention and is an indication of how far the wheel-side portion of the Linkage has traveled past its maximum leverage point. The wheel-side portion of the Linkage is at the maximum leverage point when A is zero and is considered to be prior to this point when A is negative.

On the spring-side portion of the Linkage, the geometry of the bellcrank 600 in combination with the length and orientation of spring axis G result in the instantaneous spring-side lever arm H. The corresponding angle B as illustrated has a negative value and is an indication of how far the spring-side portion of the Linkage is prior to its maximum leverage point. The spring-side portion of the Linkage is at the maximum leverage point when B is zero and is considered to be past this point when B is positive.

FIG. 4 is a diagram showing the relationship of the above geometric parameters at Full Droop (d suffix), Rideheight (r suffix) and Full Bump (b suffix).

The formula for calculating the Motion Ratio of the illustrated Linkage of the present invention at any point ‘x’ in Wheel travel is (Ex/C)*(Hx/Fx) and the corresponding Wheel Rate Gain at that point is therefore ((Ex/C)*(Hx/Fx))̂2. The specific values for these parameters may be calculated geometrically from Suspension design data if available, or measured directly from a CAD or physical model, or measured from actual installation of a Suspension at the prescribed points.

In order to achieve desired characteristics, a designer of a Linkage of the present invention can control a number of parameters. They include but are not limited to length of instantaneous pushrod D, length and orientation of Spring/Damper axis G, as well as position, overall size and geometry of bellcrank 600. For example, increasing the overall size of the bellcrank, or more particularly reducing the ratio of E to F, will reduce the changes in angles A and B for a unit of Wheel travel and will generally reduce Progression. The converse is also true, reducing the overall size of the bellcrank, and more particularly increasing the ratio of E to F, will generally result in greater changes in A and B per unit of Wheel travel and facilitate greater Progression. Ensuring that A is positive and B is negative at Full Droop will result in a Progressive linkage, although some Progressive Linkages can be configured where either or both of these conditions are not met.

When an Automobile's Sprung Mass is subjected to accelerative forces, either longitudinally from acceleration/braking, or laterally from cornering, a weight transfer occurs resulting some Wheels seeing an increased Wheel Force (loaded side) and others seeing a corresponding decrease in Wheel Force (unloaded side). A rotational moment is imparted on the Sprung Mass, in pitch responsive to longitudinal acceleration and in roll responsive to lateral acceleration. This moment is resisted by the combined Spring Force on the loaded side, acting by means of corresponding Linkages, and promoted by the combined Spring Force on the unloaded side, acting by means of corresponding Linkages.

The analysis of the effects of the Linkage of the present invention on controlling Sprung Mass motion centers around the rapid increase in Wheel Rate with compression on the loaded side and a simultaneous rapid decrease in Wheel Rate with extension on the unloaded side. The loaded Springs rapidly gain mechanical leverage and simultaneously see an increase in Motion Ratio, while the unloaded Springs rapidly lose mechanical leverage and see a decrease in Motion Ratio. As a result the forces resisting Sprung Mass motion are rapidly increasing responsive to said motion, while forces promoting the motion are simultaneously and rapidly decreasing. This in turn results in Sprung Mass motion that is significantly reduced compared to that of an Automobile with a Linear or Regressive Suspension Linkage, for a given accelerative load. The greater the Progression of a Linkage, the more pronounced is the effect.

The result is similar to that produced by a Stabilizer in roll, but unlike a Stabilizer a Linkage of the present invention is also responsive to Sprung Mass motion in pitch and in heave. Analysis of such effect is usually performed considering the motion and forces acting upon the Sprung Mass relative to the road surface as a fixed frame of reference. The details of such analyses are very dependent on the particulars of each embodiment, such as height of center of gravity, Control Arm geometry and others, and shall be apparent to those skilled in the art based on the disclosures herein. As such the detailed analysis of Sprung Mass motion and the corresponding Sprung Natural Frequency is outside the scope of the present invention.

It has been determined by the author experimentally through testing various configurations that it is desirable to have Rideheight approximately halfway in the available Wheel travel, so that Droop Travel and Bump Travel are approximately equal. It has further been found that Wheel Force of approximately four times the Corner Weight at Full Bump is desirable, corresponding to 4 g loading in that condition. A Motion Ratio of approximately 0.8 at Rideheight, approximately 0.5 at Full Droop and approximately 1.2 in Full Bump has been found to produce the desired characteristics. This corresponds to a Progression of approximately 2.4 and resulting Wheel Rate Gain of approximately 5.8. The testing has also shown that noticeable improvements over a Linear or Regressive Linkage start to manifest at Progressions above 1.2 with corresponding Wheel Rate Gains above 1.4. Due to the exponential relationship between Progression and Wheel Rate Gain, even small increases in Progression above 1.2 produce rapid increases in Wheel Rate Gain and the corresponding improvements in the dynamic characteristics of the Automobile. Progressions below approximately 1.2 have not shown significant improvements over a Linear linkage, however Regressive Linkages have been shown to perform poorly and in some cases have contributed to mechanical failure due to bellcrank over-centering.

The method of configuring the geometry of a Linkage of the present invention comprises the following steps for at least one Wheel of each Axle:
A) Determine basic design parameters such as Corner Weight, Control Arm geometry, Damper length and the desired Rideheight, Full Droop and Full Bump reference points and the desired Wheel Rate Gain.
B) Determine a desired Motion Ratio at Rideheight. Testing has shown that approximately 0.8 is a good value, although other values can be used within the scope of the present invention.
C) Determine a desired Spring Rate based on Corner Weight, Motion Ratio and the desired Rideheight position determined in step A). Unsprung Natural Frequency analysis can be optionally performed at this point to determine desired Damper characteristics, and Sprung Natural Frequency analysis can optionally be performed to check that desired comfort levels will be achieved. Neither of these analyses are essential to the present invention and are only included herein for reference.
D) With the geometry generated so far, calculate or measure Motion Ratio at Full Droop.
E) With the geometry generated so far, calculate or measure Motion Ratio at Full Bump.
F) If the desired Progression is not achieved, adjust design parameters as necessary while maintaining the Motion Ratio at Rideheight determined in B), then repeat steps D)-F).

Through both theoretical analysis and subsequent reduction to practice and comparative testing, Automobiles with Suspensions constructed in accordance with the present invention have been shown to outperform same Automobiles with Suspensions constructed in accordance with prior art, including the author's earlier designs. For example, substituting a highly Progressive Linkage of the present invention in place of an earlier slightly Progressive Linkage on Palatov D2 and a Palatov D4 Automobiles has resulted in significant improvements in dynamic stability, mechanical grip and compliance over rough pavement. Similar gains have been shown on other existing designs that utilize Linkage Suspensions of the prior art. Automobiles having Suspensions constructed in accordance with the present invention exhibit the desired Suspension compliance and control of Sprung Mass motion without the use of partial solutions such as Stabilizers, Bump Stops, Third Springs or the like, thereby achieving all the objectives of the present invention.

The embodiments disclosed herein are illustrative and not limiting; other embodiments shall be readily apparent to those skilled in the art based upon the disclosures made herein, without departing from the scope of the present invention, including embodiments utilizing alternate Linkage geometries to achieve the desired Progression.

### REFERENCES

1. U.S. D700,112 Progressive rate spring for a suspension, Noble
2. U.S. Pat. No. 8,439,173 Methods and apparatus for a suspension system with progressive resistance, Golpe, et al.
3. U.S. D630,137 Progressive rate spring for a suspension, Noble
4. U.S. Pat. No. 7,784,805 Progressive compression suspension, Morgan
5. U.S. Pat. No. 7,357,404 Progressive rate ATV suspension linkage, Sommers
6. U.S. Pat. No. 6,823,958 Progressive suspension device for the rear wheel of a motorcycle, Domenicali, et al.
7. U.S. Pat. No. 6,354,391 Progressive rate suspension spring tensioning device, Cormican

What is claimed is:

1. An Automobile comprising at least an Axle, said Axle further comprising a Suspension, said Suspension further comprising at least a left and a right Linkage, each said Linkage being mechanically coupled to at least a Spring, each said Linkage being configured to have a Wheel Rate Gain of at least 1.4.

2. The Automobile of claim 1, wherein each said Linkage is mechanically coupled to at least a Damper, each said Linkage being configured to have a Progression of at least 1.2.

3. A Suspension for an Automobile, said Suspension further comprising at least a Linkage, said Linkage being mechanically coupled to at least a Spring, said Linkage being configured to have a Wheel Rate Gain of at least 1.4.

4. The Suspension of claim 3 wherein said Linkage is mechanically coupled to at least a Damper, said Linkage being configured to have a Progression of at least 1.2.

5. A method of configuring an Automobile Suspension Linkage, said method comprising the steps of:
A) Determining basic design parameters including but not limited to Corner Weight, Control Arm geometry, Damper length, the desired Rideheight, Full Droop and Full Bump reference points, and the desired Progression.
B) Determining a desired Motion Ratio at Rideheight.
C) Determining a desired Spring Rate.
D) With the geometry generated so far, determining Motion Ratio at Full Droop.
E) With the geometry generated so far, determining Motion Ratio at Full Bump.
F) If the desired Progression is not achieved, adjusting design parameters as necessary while maintaining the Motion Ratio at Rideheight determined in B), then repeating steps D)-F).

6. The Automobile of claim 1, said Automobile having at least three wheels.

7. The Automobile of claim 1, said Automobile having at least four wheels.

8. The Suspension of claim 3 comprising a first Linkage being mechanically coupled to a Spring and further comprising a second Linkage being mechanically coupled to a Damper.

9. The Automobile of claim 1, wherein each said Linkage is mechanically coupled to at least a Spring, each said Linkage being configured to have a Wheel Rate Gain of at least 4.

10. The Automobile of claim 1, wherein each said Linkage is mechanically coupled to at least a Damper, each said Linkage being configured to have a Progression of at least 2.

11. The Suspension of claim 3 wherein said Linkage is mechanically coupled to at least a Spring, said Linkage being configured to have a Wheel Rate Gain of at least 4.

12. The Suspension of claim 3 wherein said Linkage is mechanically coupled to at least a Damper, said Linkage being configured to have a Progression of at least 2
